(19) United States
(12) Patent Application Publication
(10) Pub. No.: US 2009/0185218 A1
(43) Pub. Date: Jul. 23, 2009

(54) Printing System, Printing Device and Printing Device Maintenance Method

(75) Inventor: Osamu AZAMI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/352,412

(22) Filed: Jan. 12, 2009

(30) Foreign Application Priority Data
Jan. 23, 2008 (JP) 2008-012730

(51) Int. Cl. G06F 3/12

(52) U.S. Cl. 358/1.15

(57) ABSTRACT

A printing system in which a printing apparatus and a host device are connected on a network, wherein the printing apparatus has a starting unit that, when power is turned on under prescribed conditions, starts up the printing apparatus based on a prescribed network setting differing from that used during regular use while retaining the network setting used during regular use, and the host device has: a recognition unit that recognizes the printing apparatus started up based on the prescribed network setting differing from that used during regular use, and an inspection unit that acquires prescribed information from the printing apparatus after the printing apparatus has been recognized.

The entire disclosure of Japanese Patent Application No. 2008-12730, filed on Jan. 23, 2008, is expressly incorporated by reference herein.

### BACKGROUND

1. Technical Field

The present invention relates to a printing system for ascertaining the status of a printing device using a host device connected on a network, a printing device, and a printing device maintenance method.

2. Related Art

The status of a printing device is typically ascertained using a host device connected on a network. For example, when providing service support (or maintenance) for a printing device, the status of the printing device can be confirmed (inspected) by connecting a personal computer to the printing device.

However, in the case of performing maintenance on a printing device by connecting a personal computer, the printing device was connected to a maintenance personal computer by changing the settings to maintenance use after confirming and keeping a separate record of (recording) of the current user environment of the printing device. Since a task involving returning the printing device to the separately recorded user environment is then performed following maintenance, maintenance processing was complex. In addition, since an unspecified large number of printing devices targeted for maintenance are connected, management of the maintenance personal computer for specifying a printing device on a network involved considerable work.

For example, in the case of connecting a printing device and a personal computer using a TCP/IP connection, it is necessary to specify the IP address of the printing device to undergo maintenance while also requiring gateway and other routing information. The procedure for setting this IP address can be performed manually or automatically (DHCP, BOOTP), and the setting procedure differs for each user (namely, for each printing device).

In addition, in the case of connecting a printing device and a personal computer on a network via a USB (Universal Serial Bus) interface, since a connection port corresponding to an unique USB ID assigned to each printing device is set in order to distinguish the devices, the port number increases each time a different printing device is connected even if not connected simultaneously at the time of maintenance. Since devices are only supported up to 256 ports even in the popular Windows operating environment (Windows is a registered trademark of Microsoft Corporation, USA), unless connection port information corresponding to unique USB IDs are deleted such as by clearing the registry at the point 256 different printing devices have been connected, a new printing device cannot be recognized (namely, cannot be connected). Furthermore, it goes without saying that this problem is not limited to the Windows operating environment, but rather the same problem occurs in environments in which the port number increases each time a different printing device is connected.

### SUMMARY

An advantage of some aspects of the invention is to provide a printing system, which is capable of easily specifying a printing device (printing apparatus) without having to set each printing device connected on a network as well as eliminating the need to separately record a user environment when acquiring prescribed information from a printing device by connecting to a printing device, a printing device and a printing device maintenance method.

According to an aspect of the invention, in a printing system in which a printing device and a host device are connected on a network, when a power source is turned on under prescribed conditions, a starting unit of the printing device starts up the printing device based on a prescribed network setting differing from that during regular use while retaining the network setting used during regular use, and a recognition unit of the host device recognizes the printing device started up based on the prescribed network setting differing from that used during regular use. While in this state, an inspection unit of the host device acquires prescribed information from the printing device or sets the printing device to a prescribed status. Thus, even in the case of a different printing device having been connected, since the printing device is turned on under prescribed conditions, the host device is able to recognize that the same printing device has been connected based on the prescribed network setting.

As a result, when acquiring prescribed information from a printing device by connecting to that printing device, such as when performing maintenance on the printing device by connecting a personal computer, an unspecified large number of printing devices can be easily specified without having to set each printing device on the network or set the host device each time such maintenance is performed. In addition, since the printing device starts up based on the network setting used during regular use if the power of the printing device is turned on normally, it is not necessary to confirm and separately record the current user environment of the printing device.

It is preferable that the printing device and the host device are connected on a network via a USB interface. In this case, the prescribed network setting is such that a common USB ID, which differs from the unique USB ID for each printing device used based on the network setting used during regular use, is used for the USB ID of the printing device for the USB interface. The recognition unit then recognizes a printing device based on the common USB ID. Thus, even if printing devices having different unique USB Ids are connected, the host device is able to recognize that the same printing devices have been connected by the common USB ID, thereby enabling the printing devices to be operated with the same connection port.

As a result, when acquiring prescribed information from a printing device by connecting to that printing device, since the port number does not increase even if different printing devices are connected, a new printing device can be recognized (namely, can be connected) without having to delete information of the connection port corresponding to a unique USB ID.

In addition, it is preferable that the printing device and the host device be connected via TCP/IP. In this case, the prescribed network setting is such that the IP address setting method for the printing device is set automatically by a DHCP server. In addition, since the host device is provided with a DHCP server function, when the printing device has started up based on this prescribed network setting, a common IP address is assigned to the printing device. Alternatively, in the case the printing device and the host device are connected via TCP/IP, the prescribed network setting is such that the IP address of the printing device is set manually, and IP address of the printing device may be a common IP address differing from the IP address assigned on the basis of the network setting used during regular use. The recognition unit then recognizes a printing device based on the common IP address. Thus, even if different printing devices have been connected, the host device allows the printing devices to be operated according to the common IP address.

As a result, when acquiring prescribed information from a printing device by connecting to that printing device, an unspecified large number of printing devices can be recognized (namely, can be connected) without having to alter the user environment relating to the network setting.

In addition, it is preferable that the printing device be configured to ignore all recognizable errors when the power is turned on under prescribed conditions. As a result, since the printing device starts up while ignoring errors, the situation in which the printing device fails to start up when there has been an error is avoided, and the host device is able to acquire prescribed information from the printing device.

In addition, it is preferable that the printing device be configured to set a paper setting to a prescribed paper setting value when the power is turned on under prescribed conditions. As a result, the situation in which, for example, a test form and the like is not output when the paper setting is that of a user environment, is avoided.

Moreover, the technical idea according to the invention can also be understood in the form of an invention other than the printing system described above. One example thereof is a printing device connected with a host device on a network, the printing device being provided with a starting unit, which, when started up under prescribed conditions, starts up the printing device based on a prescribed network setting differing from that used during regular use while retaining the network setting used during regular use, wherein when the power has been turned on under the prescribed conditions, the printing device is recognized by the host device based on the prescribed network setting, thereby making it possible to ascertain a printing device for which prescribed information is to be acquired.

In addition, the invention can also be understood to be a printing device maintenance method having steps corresponding to each operation carried out by each apparatus in the printing system described above. Namely, the invention can be understood to be a printing device maintenance method using a host device connected on a network, including: starting up the printing device based on a prescribed network setting differing from that used during regular use while retaining the network setting used during regular use by turning on the power under prescribed conditions, causing a host device to recognize the printing device started up based on the prescribed network setting differing from that used during regular use, and acquiring prescribed information from the printing device by the host device after having recognized the printing device.

### BRIEF DESCRIPTION OF THE DRAWINGS

The invention will be described with reference to the accompanying drawings, wherein like numbers reference like elements.

FIGS. 1A and 1B show a sketch drawing exemplifying a printing system of the invention.

FIG. 2 shows a block diagram exemplifying a schematic configuration of a printing system.

FIG. 3 shows a flow chart indicating a control operation executed by a printing control unit.

FIG. 4 shows a flow chart indicating a control operation executed by a printer control unit.

FIG. 5 shows a flow chart indicating a control operation executed by a printer control unit.

FIG. 6 shows another flow chart indicating a control operation executed by a printer control unit.

FIG. 7 shows a flow chart indicating a control operation executed by a printer control unit.

### DESCRIPTION OF EXEMPLARY EMBODIMENTS

The following provides an explanation of exemplary embodiments of the invention with reference to the attached drawings in the order indicated below.
1. Schematic configuration of printing system
2. Operation of printing device during maintenance
3. Variation 1
4. Variation 2
5. Variation 3

### 1. Schematic Configuration of Printing System

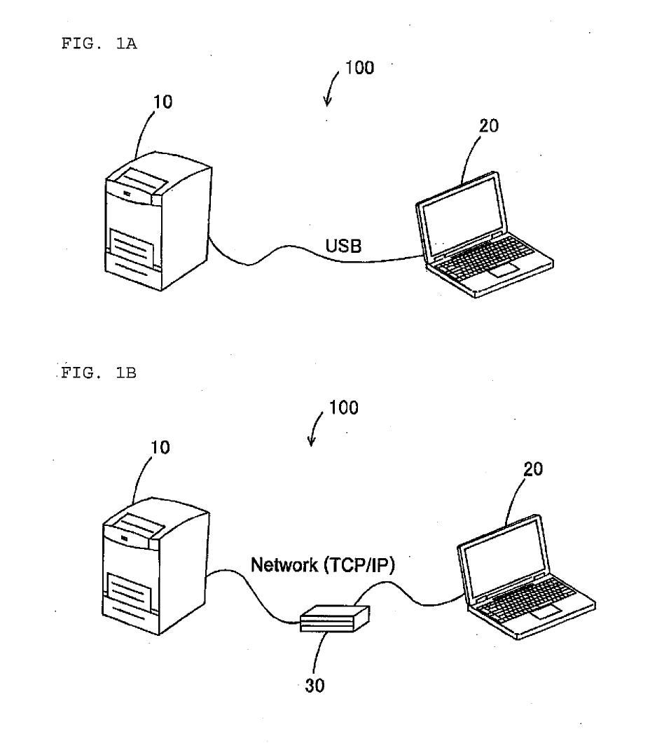

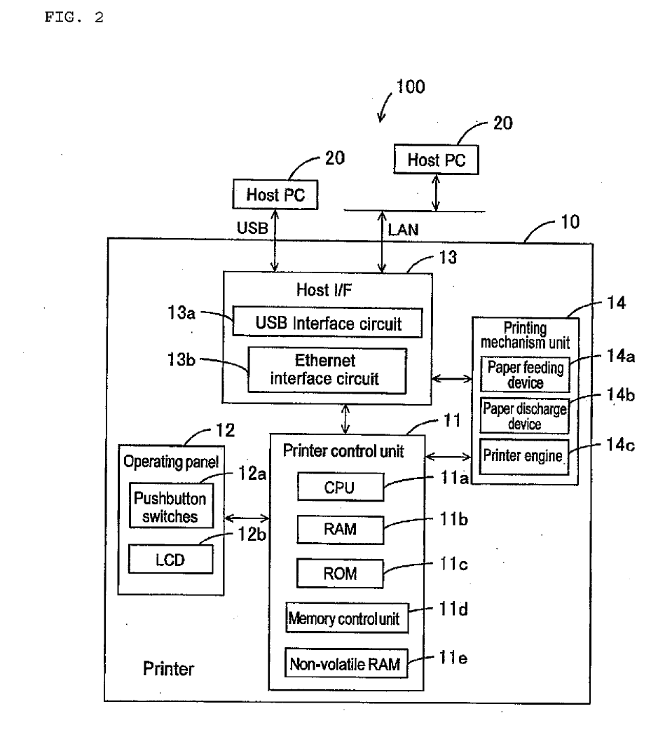

FIG. 1 shows a sketch drawing of a printing system 100 according to one embodiment of the invention, while FIG. 2 shows a block diagram of the printing system 100.

In FIGS. 1 and 2, the printing system 100 is a system in which a printing device 10 and a host device in the form of a PC 20 are connected on a network. For example, the printing device 10 and the PC 20 may be connected on a network via a USB interface (FIG. 1A in particular), or may be connected via TCP/IP on an Ethernet (Ethernet is a registered trademark of Fuji Xerox Co., Ltd.) interposed with a switching hub 30 and the like (FIG. 1B in particular).

The printing device 10 is a network-compatible printer provided with a printer control unit 11, an operating panel 12, a host I/F 13, and a printing mechanism unit 14.

The printer control unit 11 is provided with a CPU 11a, a RAM 11b, a ROM 11c, a memory control unit 11d, a non-volatile RAM 11e and the like. The printer control unit 11 is a unit that performs processing such as generating printed matter having contents corresponding to printing job data received from the host PC 20 in the printing mechanism unit 14, or returning status information representing the status of the printing device 10 (such as usable functions or residual amounts of consumables) to a device that has requested that information.

The CPU 11a comprehensively controls each part of the printer control unit 11 in accordance with a program stored in the ROM 11c and the like. The RAM 11b is memory used to temporarily store data such as printing job data received from the host I/F 13 or data generated by the CPU 11a based on that printing job data. In addition, the RAM 11b is also memory read by a program from the ROM 11c. The ROM 11c is non-volatile memory in which various programs loaded in the RAM 11b and executed by the CPU 11a are stored in a compressed state. Default settings for the environment of the printing device 10 in the form of factory settings are stored in advance in the ROM 11c. The memory control unit lid performs processing such as transferring data from the host I/F 13 to the RAM 11b in accordance with instructions of CPU 11a or transferring data from the RAM 11b to a printer engine 14c within the printing mechanism unit 14. The non-volatile RAM 11e is a rewritable non-volatile memory (such as EEPROM or NVRAM) installed in the printing device 10 (the printer control unit 11) in the form of a storage device of various information to be stored even if the power is turned off. A user environment in the form of panel settings is stored in this non-volatile RAM 11e. The user environment is stored (updated) by copying a default environment in the ROM tic to the non-volatile memory RAM 11e and sequentially updating with the operating panel 12 and settings from external devices. In addition, although not rewritable from the operating panel 12, device information such as USB ID or serial number is also stored in the non-volatile RAM 11e.

The operating panel 12 is an interface unit between a user and the printing device 10 (the printer control unit 11). This operating panel 12 is a unit provided with, for example, a plurality of pushbutton switches 12a for accepting user operations, and an LCD (liquid crystal display) 12b for displaying various messages relating to the status of the printing device 10.

The host I/F 13 is a circuit for carrying out communication (information exchange) with the host PC 20, and is provided with a USB interface circuit 13a and an Ethernet interface circuit 13b. The printing mechanism unit 14 is a mechanism for actually carrying out printing onto paper, and is provided with, for example, a paper feeding apparatus 14a, a paper discharge apparatus 14b and the printer engine 14c.

The host PC 20 is a personal computer for maintenance use (for providing service support) in which printing device control programs or utility programs all developed for use with the printing device 10 are installed in a computer having an ordinary configuration (such as a computer installed with an OS, web browser and the like) on a network on which the printing device 10 is connected. A printing device control program is a program (referred to as a so-called printer driver) for generating printing job data supplied to the printing device 10 based on data relating to a printing target document transferred from an application program (and OS). On the other hand, a utility program is a program for supplying an environment facilitating simple utilization of reserve job data stored in the printing device 10 (mainly stored by the host PC 20) to a user of the host PC 20. In addition, the host PC 20 is functionally provided with a recognition unit for recognizing the printing device 10 based on a network setting, and an inspection unit for acquiring prescribed information from the printing device 10 after having recognized the printing device 10. For example, in the case of a normal network setting, the printing device 10 is recognized with a well-known unique USB ID of the printing device 10 for a USB interface, and in the case a different printing device 10 is connected, a different USB port corresponding to each USB ID unique to that printing device 10 is set respectively. In addition, the printing device 10 can also be recognized with an IP address set for the printing device 10.

In the printing system 100 configured in the manner described above, the printer control unit 11 in particular is functionally provided with a starting unit that starts up the printer apparatus (printing device) 10 based on a prescribed network setting differing from that used during regular use while retaining the network setting used during regular use when the power thereof is turned on under prescribed conditions. The prescribed network setting differing from that used during regular use is realized by, for example, using the USB ID of the printing device 10 as a common USB ID for each printing device 10 that differs from the unique USB ID for each printing device 10 used based on the network setting used during regular use. In addition, turning on the power under prescribed conditions refers to the case of, for example, carrying out a special (prescribed) key input with the pushbutton switches 12a of the operating panel 12 when the power of the printing device 10 is turned on. In addition, the common USB ID is presumed to be a specific USB ID in the manner of, for example, a USB ID in which all characters thereof are zero, that cannot be found on the market.

In this embodiment, the state of being started up by carrying out a special key input is referred to as a service support mode. The settings of the printing device 10 during this service support mode are stored in advance in the ROM 11c in the same manner as the factory settings, are supplied to the non-volatile RAM 11e when in the service support mode, and are only active in the service support mode without overwriting the previously written user environment.

When in this service support mode, the host PC 20 is able to recognize that the same printing device has been connected based on the common USB ID as a result of the power of the printing device 10 having been turned on under the prescribed conditions even if a different printing device 10 has been connected, thereby enabling the printing device 10 to operate with the same connection port.

### 2. Operation of Printing Apparatus During Maintenance

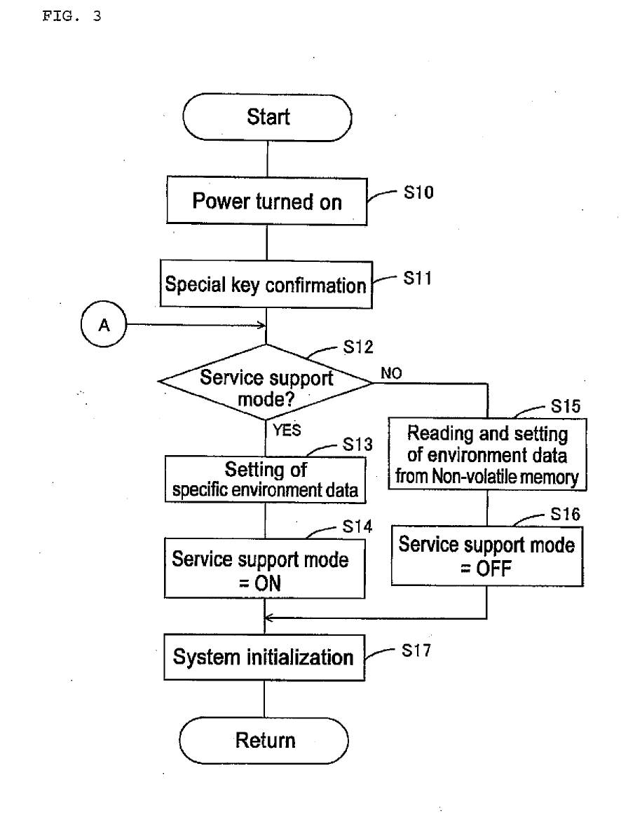

FIGS. 3 to 5 show flow charts indicating a control operation when power is turned on executed by the printer control unit 11 of the printing device 10 in accordance with a prescribed program stored in the ROM 11c.

In FIG. 3, when the power of the printing device 10 is turned on in step S10 (the term “step” will be omitted in subsequent descriptions), a special key input performed by operating the pushbutton switches 12a is simultaneously confirmed in S11.

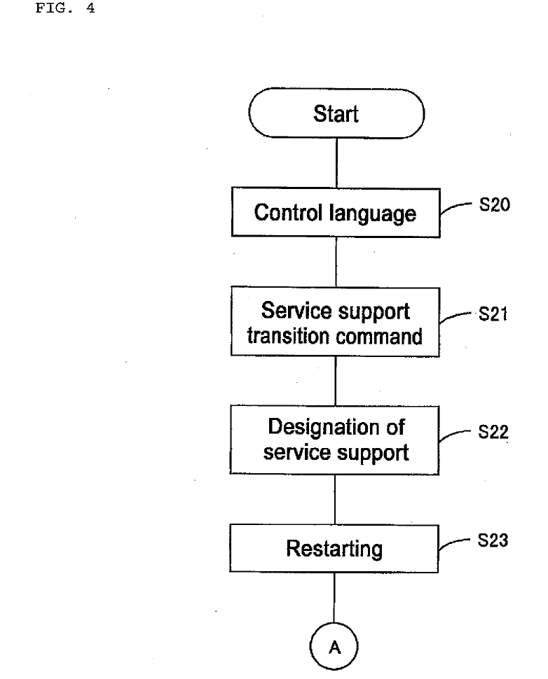

In the case the special key input has been confirmed when the power has been turned on, as shown in FIG. 4, a service support transition command is issued in S20 that restarts the printing device 10 in a special mode (here referred to as the service support mode) possessed by a control language of the printing device 10. Next, in S21, the service support transition command is interpreted. Moreover, in S22, service support is designated, and in S23, the printing device 10 is restarted so as to switch to the service support mode.

Returning to FIG. 3, a judgment is made as to whether or not the printing device 10 has been switched to the service support mode in S12. If the judgment of S12 is in the affirmative (Yes), special environment data, namely service support environment data, is set in S13. Next, in S14, a flag of the service support mode is switched on. The service support environment data refers to, for example, a prescribed paper setting value set as a paper setting for avoiding a situation in which a test form is not output during maintenance.

On the other hand, if the judgment of S12 is in the negative (No), user environment data is read from the non-volatile RAM 11e and set in S15. Next, in S16, the flag of the service support mode is switched off. Operation then proceeds to S14 or S16, and the system is initialized in S17.

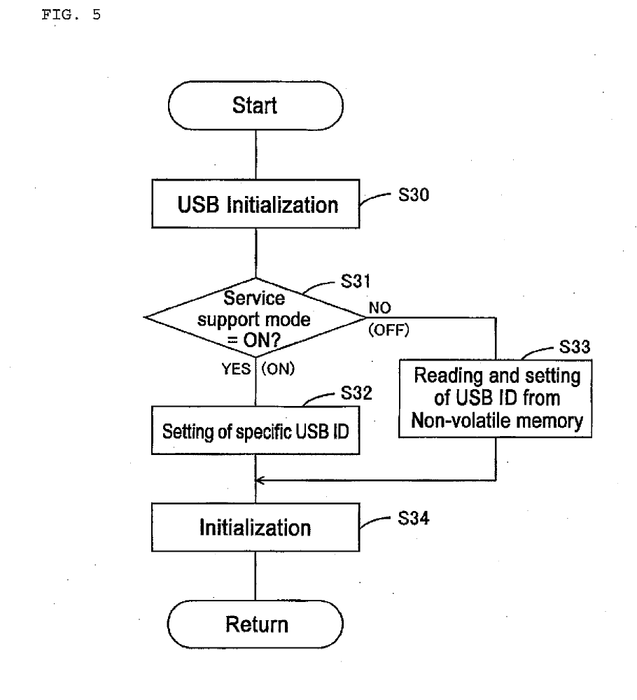

When the system is initialized, USB initialization is executed in S30 as shown in FIG. 5. First, in S31, a judgment is made as to whether or not the flag of the service support mode is on. If the judgment of S31 is in the affirmative (Yes), then a common (specific) USB ID is set in S32.

On the other hand, if the judgment in step S31 is in the negative (No), then a unique USB ID is read from the non-volatile RAM 11e and set in S33. Operation then proceeds to S32 or S33 and initialization is executed in S34.

Thus, regardless of which printing device 10 is connected, as a result of the printing device 10 being turned on under the prescribed conditions, the host PC 20 is able to recognize that the same printing device has been conducted by a certain USB ID common for each printing device 10, thereby enabling the printing device to operate with the same connection port. As a result, when performing maintenance on the printing device 10 by connecting the host PC 20, for example, since there is no increase in the port number even if different printing devices are connected, a new printing device can be connected without having to delete information on the connection port corresponding to a unique USB ID for each printing device 10, thereby making it possible to easily specify an unspecified large number of printing devices.

In addition, since the settings of the printing device 10 when in the service support mode are only active in the service support mode without overwriting a previously written user environment, the printing device 10 starts up based on the network setting used during regular use if the power is turned on normally, thereby eliminating the need to confirm and separately record the current user environment of the printing device 10.

### 3. Variation 1

Although service maintenance is performed on the printing device 10 by connecting the printing device 10 and the host PC 20 on a network via a USB interface in the embodiment described above, service maintenance may also be performed on the printing device 10 by connecting the printing device 10 and the host PC 20 using a TCP/IP connection.

In this case, the prescribed network setting during the service support mode is realized by using automatic setting by a DHCP server for the IP address setting procedure of the printing device 10. In addition, the host PC 20 is provided with a DHCP server function, and assigned a common IP address to the printing device 10 when the printing device 10 has been started up with the prescribed network setting. When in this service support mode, the host PC 20 can recognize the printing device 10 by the common IP address as a result of turning on the power of the printing device 10 under prescribed conditions.

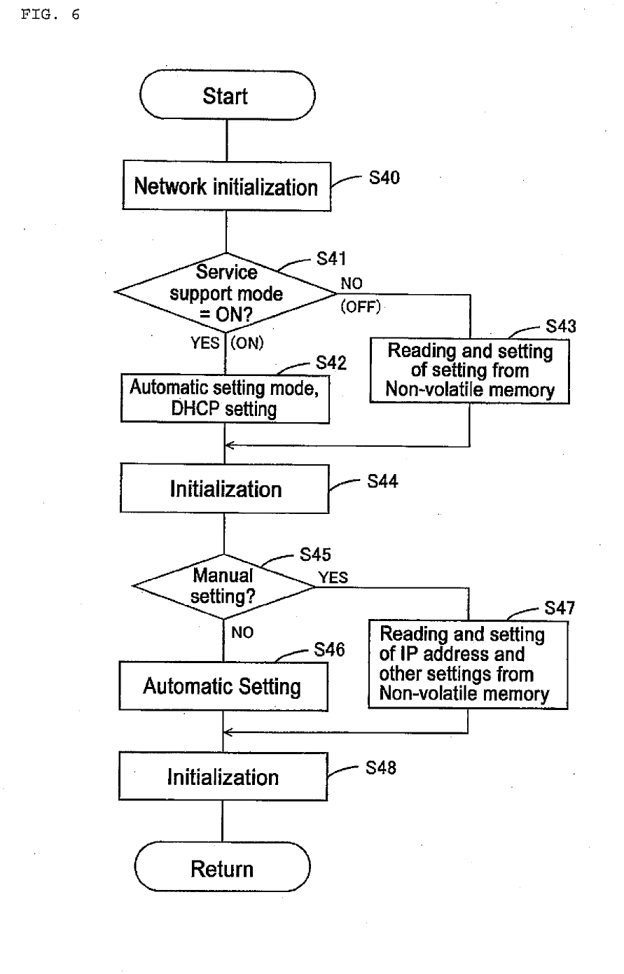

FIG. 6 shows a flow chart indicating another embodiment corresponding to FIG. 5 of a control operation when power is turned on executed by the printer control unit 11 of the printing device 10 in accordance with a prescribed program stored in the ROM 11c.

When the system is initialized in S17 of FIG. 3, Ethernet network initialization is executed in S40 as shown in FIG. 6. First, in S41, a judgment is made as to whether or not the flag of the service support mode is on. If the judgment of S41 is in the affirmative (Yes), in S42 the IP address setting procedure of the printing device 10 is set to automatic setting by a DHCP server. On the other hand, in the case the judgment in S41 is in the negative (No), the network setting used during regular use is read from the non-volatile RAM 11e and set in S43. Operation then proceeds to S42 or S43 and initialization is executed in S44.

Next, in S45, a judgment is made as to whether or not the IP address setting procedure is set to manual. In the case the judgment of S45 is in the negative (No), in S46 the IP address of the printing device 10 is set automatically. Namely, the IP address of the printing device 10 is set to a common IP address assigned by the host PC 20. On the other hand, in the case the judgment of S45 is in the affirmative (Yes), the IP address and other setting values used during regular use are read from the non-volatile RAM 11e and set in S47. Operation then proceeds to S46 or S47 and initialization is executed in S48.

Thus, the host PC 20 is able to operate the printing device 10 by a common IP address even in the case different printing devices have been connected. As a result, when performing maintenance on the printing device 10 by connecting the host PC 20, for example, an unspecified large number of printing devices can be recognized without having to alter the user environment relating to network settings.

### 4. Variation 2

The prescribed network setting in Variation 1 may also be realized by setting the IP address setting procedure of the printing device 10 to manual setting, and using a common IP address differing from the IP address assigned with network settings used during regular use for the IP address of the printing device 10. Namely, the IP address setting procedure of the printing device 10 may be set to manual setting for setting a common IP address in S42 of FIG. 6. Furthermore, in this case, the host PC 20 is not necessarily required to be provided with a DHCP server function.

### 5. Variation 3

Since there is the risk of a situation that prevents maintenance from being performed as a result of the printing device being unable to start up normally if an error judgment is carried out by the printing device 10 when in the service support mode, the printing device 10 may be allowed to start up while ignoring all recognizable errors when the power is turned on under prescribed conditions.

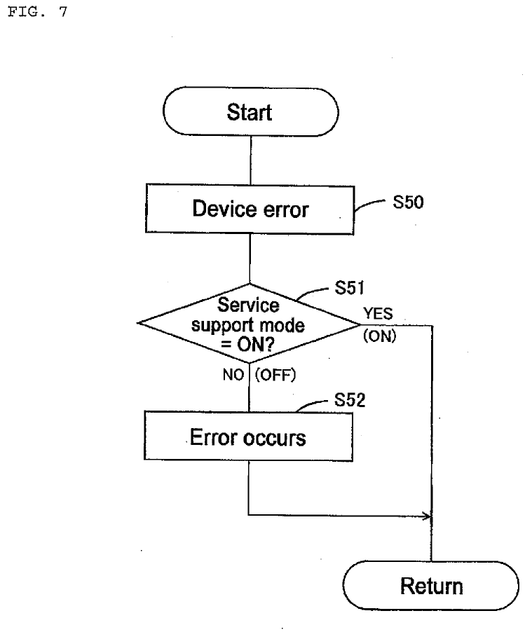

FIG. 7 shows a flow chart indicating a control operation during error judgment executed by the printer control unit 11 of the printing device 10 in accordance with a prescribed program stored in the ROM 11c.

In FIG. 7, when a device error in the printing device 10 is confirmed in S50, a judgment is made in S51 as to whether or not the flag of the service support mode is on. In the case the judgment of S51 is in the negative (No), a prescribed processing is executed corresponding to the occurrence of each error in S52. On the other hand, in the case the judgment of S51 is in the affirmative (Yes), the error processing routine is terminated without the prescribed processing being executed in S52. In other words, the occurrence of the error is ignored. As a result, since the printing device 10 starts up while ignoring errors, the situation in which the printing device 10 fails to start up normally when an error has occurred is avoided, thereby enabling prescribed information to be acquired from the printing device 10.

Although the above has provided a detailed explanation of embodiments of the invention based on the drawings, the invention is also applied to other aspects thereof. For example, the technical idea of the invention can also be understood as an invention other than the previously described printing system 100. As an example thereof, the invention can also be understood to be a maintenance method for the printing device 10 having steps corresponding to each operation carried out by the printing device 10 and the host PC 20 in the previously described printing system 100.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A printing system in which a printing device and a host device are connected on a network, wherein
the printing device has a starting unit that, when power is turned on under prescribed conditions, starts up the printing device based on a prescribed network setting differing from that used during regular use while retaining the network setting used during regular use, and
the host device has:
a recognition unit that recognizes the printing device started up based on the prescribed network setting differing from that used during regular use, and
an inspection unit that acquires prescribed information from the printing device after the printing device has been recognized.

2. The printing system according to claim 1, wherein
the printing device and the host device can be connected on a network via a USB interface,
the prescribed network setting sets a USB ID of the printing device for the USB interface to a common USB ID differing from a unique USB ID used at the network setting used during regular use, and
the recognition unit recognizes the printing device with the common USB ID.

3. The printing system according to claim 1, wherein
the printing device and the host device can be connected via a TCP/IP connection,
the prescribed network setting sets an IP address setting method for the printing device to automatic setting by a DHCP server,
the host device is provided with a DHCP server function, and assigns a common IP address to the printing device when the printing device has been started up based on the prescribed network setting, and
the recognition unit recognizes the printing device with the common IP address.

4. The printing system according to claim 1, wherein
the printing device and the host device can be connected via a TCP/IP connection,
the prescribed network setting sets an IP address setting method for the printing device to manual setting, and sets the IP address of the printing device to a common IP address differing from an IP address assigned to the printing device with the network setting used during regular use, and
the recognition unit recognizes the printing device with the common IP address.

5. The printing system according to claim 1, wherein the printing device ignores all recognizable errors when the power thereof is turned on under prescribed conditions.

6. The printing system according to claim 1, wherein the printing device sets a paper setting to a prescribed paper setting value when the power thereof is turned on under prescribed conditions.

7. A printing device connected with a host device on a network, comprising:
a starting unit that, when power is turned on under prescribed conditions, starts up the printing device based on a prescribed network setting differing from that used during regular use while retaining the network setting used during regular use, wherein
when the power is turned on under the prescribed conditions, the printing device is recognized by the host device based on the prescribed network setting, and prescribed information is acquired.

8. A printing device maintenance method using a host device connected on a network, the method comprising:
starting up the printing device based on a prescribed network setting differing from that used during regular use while retaining the network setting used during regular use by turning on power under prescribed conditions;
causing the host device to recognize the printing device started up based on the prescribed network setting differing from that used during regular use; and
acquiring prescribed information from the printing device by the host device after recognizing the printing device.
